(19) United States
(12) Patent Application Publication
(10) Pub. No.: US 2005/0138563 A1
(43) Pub. Date: Jun. 23, 2005

(54) Method and system for providing computer system software images

(75) Inventors: Daryl Carvis Cromer, Apex, NC (US); Eric Richard Kern, Durham, NC (US); Howard Jeffrey Locker, Cary, NC (US); Randall Scott Springfield, Chapel Hill, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/741,463

(22) Filed: Dec. 18, 2003

(51) Int. Cl. G06F 17/00; G06F 15/177

(52) U.S. Cl. 715/735; 709/220

(57) ABSTRACT

Aspects of providing computer system software images are described. The aspects include scanning hardware present in a computer system for device identifiers. An image value is then formed from the device identifiers and utilized to ensure provision of an image appropriate for the hardware present. The utilization includes determining whether a matching image value exists for the formed image value, such that a stored image corresponding to the matching image value is downloaded to the computer system when a matching image value exists and a need for a new image to be generated for the formed image value is identified when a matching image value does not exist.

### FIELD OF THE INVENTION

The present invention relates to providing computer system software images, including validating the correctness of existing images and determining a need for new images based on the hardware physically present in a computer system.

### BACKGROUND OF THE INVENTION

Image stability is extremely important to large enterprise computer system users in today's computing environment. Large enterprises generally have a geographically dispersed network under the jurisdiction of one organization. For example, an enterprise network may comprise a main server at a central location, e.g., headquarters, coupled to a plurality of intermediate servers where each intermediate server may be located at a geographically separate location from the main server. Each intermediate server may represent a particular location, e.g., store, of an organization. Each intermediate server may then be coupled to a plurality of terminals, e.g., cash registers, personal computers, at that particular location. If the hardware changes in a given system, it requires a new image. Image creation and qualification are time-consuming processes, taking, at times, several months to complete, such as when full qualification against all applications must be performed prior to introducing a new image into the production environment. Over time, multiple images are created as the hardware changes. Also, when a new client arrives, often it is not known with certainty whether the image for the client works and/or which of many images associated with the client is correct. Unfortunately, the problem is often not identified until the client has a major error during installation or, more problematically, until running an application.

Attempts have been made to link an image with a machine number/model to try and avoid this problem. However, this approach has major limitations, since the hardware may change within a machine of a given number, such as when second stage manufacturing adds hardware options to a base machine, which changes the image needed. It is also possible that two systems with different number identifications may use the same image while having different mechanical shells and/or other differences that don't affect the image. Unfortunately, without some way of identifying such common need, efforts are duplicated in providing images to the separately identified systems.

Accordingly, a need exists for an efficient and effective manner of providing computer system software images, including validating the correctness of existing images and determining a need for new images based on the hardware physically present in a computer system. The present invention addresses such a need.

### SUMMARY OF THE INVENTION

Aspects of providing computer system software images are described. The aspects include scanning hardware present in a computer system for device identifiers. An image value is then formed from the device identifiers and utilized to ensure provision of an image appropriate for the hardware present. The utilization includes determining whether a matching image value exists for the formed image value, such that a stored image corresponding to the matching image value is downloaded to the computer system when a matching image value exists and a need for a new image to be generated for the formed image value is identified when a matching image value does not exist.

The present invention provides a straightforward and efficient manner of utilizing a real-time scan of hardware registers of subsystems within a client that creates a unique identifier for use in identifying which image will match the hardware. Through the present invention, the total number of images required is reduced. These and other advantages of the present invention will be more fully understood in conjunction with the following detailed description and accompanying drawings.

### BRIEF DESCRIPTION OF THE DRAWINGS

FIG. 1 illustrates an overall diagram of an example of a network arrangement for implementing an automatic image determination for client image download in accordance with the present invention.

FIG. 2 illustrates an overall block flow diagram for a method of automatic image determination for client image download in accordance with the present invention.

### DETAILED DESCRIPTION

The present invention relates to providing computer system software images, including validating the correctness of existing images and determining a need for new images based on the hardware physically present in a computer system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

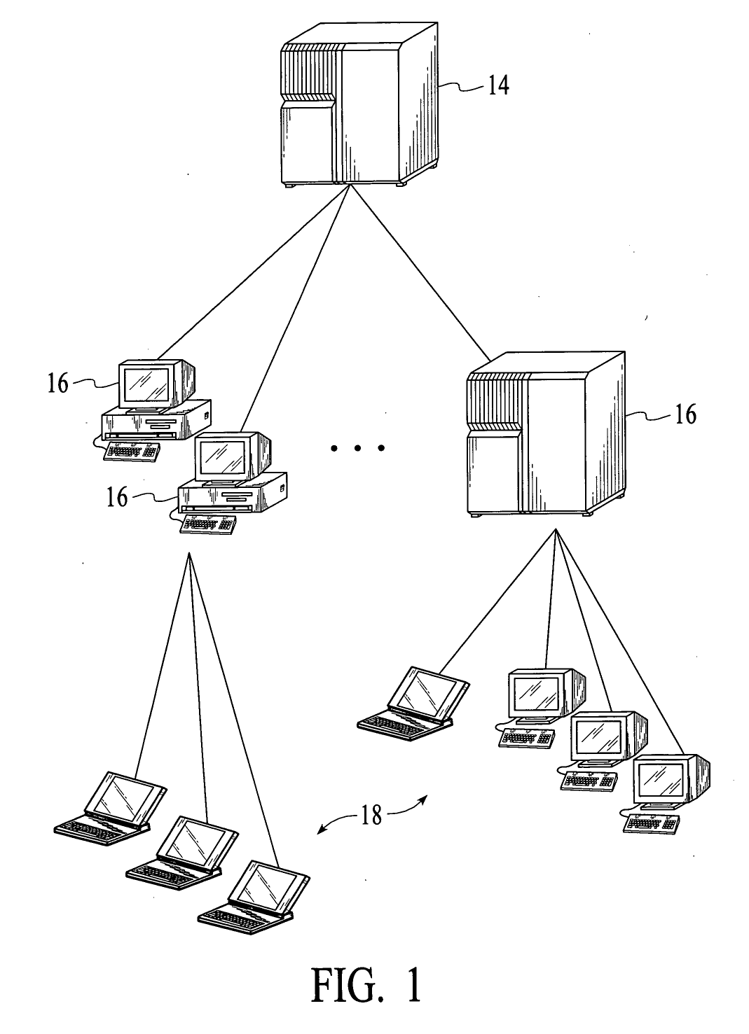

FIG. 1 illustrates an overall diagram of an example of a network arrangement, such as in an enterprise environment, for implementing an automatic image determination for client image download in accordance with the present invention. Multiple servers 14 coordinate activities across the network and permit remote site management and operation, as is well understood in the art. Each server 14 serves a number of machines 16, some of which in turn act as gateways, that support a plurality of endpoints 18 (e.g., desktop machines or laptops or complex machines or workstations). For a workgroup-size installation (e.g., a local area network), a single server-class machine may be used as the server and gateway for the client machines. Thus, the arrangement of FIG. 1 is meant as illustrative and not restrictive of the types of network arrangements suitable for implementing the aspects of automatic image determination for client image download of the present invention, the implementation occurring as program instructions on suitable computer readable media, as is well appreciated in the art. Further, it should be appreciated that the automatic image determination for client image download can be utilized in any environment that performs image downloads, including during manufacturing, deployment, etc.

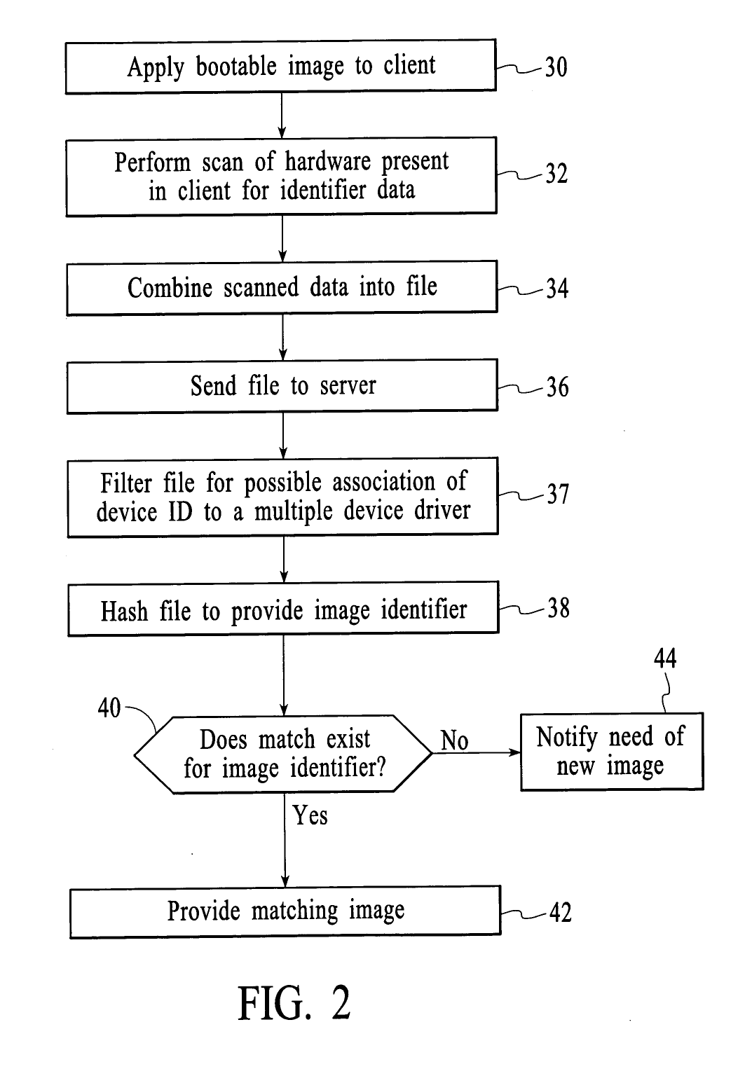

Referring now to FIG. 2, an overall block flow diagram is illustrated for a method of automatic image determination for client image download in accordance with the present invention. The method initiates with the applying of a bootable image to the client (step 30), such as during a deployment process, by any of a variety of methods, including using a floppy, CD, DVD, RSA II's Remote Disk, a bootable USB key, and/or Pxe download from a network. The bootable image performs a scan of the hardware to determine the hardware present in the system by reading all of the PCI registers, USB IDs (identifiers), hard drive IDs, chipset IDs, etc. (step 32). The values read are then strung together within a single file (step 34). The single file is then sent to the server (step 36).

In addition to this image identification file, further consideration is made for those systems having one driver that supports multiple and different devices. Commonly, super drivers are created to support the latest and all previous levels of hardware. Therefore, adding a filter to deal with this possibility reduces the number of discrete images required on the server. For example, since multiple PCI devices could use the same set of drivers, in addition to the aforementioned steps, the server also performs a data look-up on the PCI device to determine which drivers are appropriate (step 37). When the file is sent to the server the server can scan the file and replace PCI device ID and/or USB ID from earlier levels of hardware with the latest PCI device ID that represents the super driver based on a database search. By performing this operation on all devices, a result is generated that is used as the image identifier file for all of those devices. With the addition of this step, one image identifier file supports different levels of hardware that an IT administrator has already tested and validated.

The server then hashes the file (step 38) using any desired hash algorithm, as is commonly understood in the art. The hash value provides an image identifier for the client. Any change in hardware changes the IDs read, which in turn creates a different hash value. Thus, each hash value can be linked to a unique image. The server tries to match the hash value against a known image, e.g., via a database search (step 40). If a match is found, that image is downloaded to the client (step 42). If no match is found, notification of a need for a new image occurs (step 44), such as to the IT administrator of the server.

Thus, the present invention provides a real-time scan of hardware registers of subsystems within a client that creates a unique identifier for use in identifying which image will match the hardware. The total number of images required to match all clients is significantly reduced, since one image can cover many different hardware configurations. Further, this eliminates touch points, because the IT administrator is only notified if there is no image match to the identifier.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for providing computer system software images, the method comprising:
scanning hardware present in a computer system for device identifiers;
forming an image value from the device identifiers; and
utilizing the image value to ensure provision of an image appropriate for the hardware present.

2. The method of claim 1 wherein forming an image value further comprises performing a hash operation on the device identifiers.

3. The method of claim 1 wherein utilizing the image value further comprises determining whether a matching image value exists for the formed image value.

4. The method of claim 3 wherein when a matching image value exists, the method further comprises downloading a stored image corresponding to the matching image value to the computer system.

5. The method of claim 4 wherein when a matching image value does not exist, the method further comprises identifying a need for a new image to be generated for the formed image value.

6. The method of claim 1 further comprising determining whether multiple device identifiers utilize a same device programming, and correlating image values for each of the multiple device identifiers with a same image for the same device programming.

7. A system for providing computer system software images, the system comprising:
a plurality of computer processing systems coupled in a network arrangement, the plurality of computer processing systems comprising at least one server coupled to at least one client, the at least one client performing a scan of hardware present in the at least one client to determine device identifiers, the at least one client providing the device identifiers to the at least one server, the at least one server forming an image value from the device identifiers and ensuring provision of an image appropriate for the hardware present in the at least one client based on the image value.

8. The system of claim 7 wherein the at least one server forms an image value by performing a hash operation on the device identifiers.

9. The system of claim 7 wherein the at least one server utilizes the image value by determining whether a matching image value exists for the formed image value.

10. The system of claim 9 wherein when a matching image value exists, the at least one server downloads a stored image corresponding to the matching image value to the at least one client.

11. The system of claim 10 wherein when a matching image value does not exist, the at least one server identifies a need for a new image to be generated for the formed image value.

12. The system of claim 7 wherein the at least one server determines whether multiple device identifiers utilize a same device programming, and correlates image values for each of the multiple device identifiers with a same image for the same device programming.

13. Computer readable media containing program instructions for providing computer system software images, the program instructions comprising:
scanning hardware present in a computer system for device identifiers;
forming an image value from the device identifiers; and
utilizing the image value to ensure provision of an image appropriate for the hardware present.

14. The computer readable media of claim 13 wherein forming an image value further comprises performing a hash operation on the device identifiers.

15. The computer readable media of claim 13 wherein utilizing the image value further comprises determining whether a matching image value exists for the formed image value.

16. The computer readable media of claim 15 wherein when a matching image value exists, the method further comprises downloading a stored image corresponding to the matching image value to the computer system.

17. The computer readable media of claim 16 wherein when a matching image value does not exist, the method further comprises identifying a need for a new image to be generated for the formed image value.

18. The computer readable media of claim 13 further comprising determining whether multiple device identifiers utilize a same device programming, and correlating image values for each of the multiple device identifiers with a same image for the same device programming.
